(19) United States
(12) Patent Application Publication
(10) Pub. No.: US 2017/0359343 A1
(43) Pub. Date: Dec. 14, 2017

(54) SYSTEM AND METHOD FOR SECURE COMMUNICATIONS WITH INTERNET-OF-THINGS DEVICES

(71) Applicant: ComfyLight AG, Zurich (CH)

(72) Inventors: Paul STERL, Poing (DE); Andreas DANGEL, Munich (DE)

(73) Assignee: ComfyLight AG, Zurich (CH)

(21) Appl. No.: 15/621,634

(22) Filed: Jun. 13, 2017

Related U.S. Application Data
(60) Provisional application No. 62/349,668, filed on Jun. 14, 2016.

(51) Int. Cl. H04L 29/06; H04L 29/08; H04W 4/00; H04W 12/06

(52) U.S. Cl. CPC H04L 63/0876; H04L 63/0823; H04L 67/125; H04W 4/005; H04W 12/06

(57) ABSTRACT

A system and method for securing communications between Internet of Things (IoT) devices and user devices. The method includes establishing a connection to an IoT device over a first secured communication channel, wherein the IoT device is communicatively connected to a wireless network using at least login credentials received from a user device over a second communication channel, wherein the user device is communicatively connected to the wireless network; receiving, from the IoT device, a unique identifier of the user device; and associating the user device with the IoT device, wherein only user devices that are associated with the IoT device can control the IoT device.

### CROSS-REFERENCE TO RELATED APPLICATIONS

This application claims the benefit of U.S. Provisional Application No. 62/349,668 filed on Jun. 14, 2016, the contents of which are hereby incorporated by reference.

### TECHNICAL FIELD

The present disclosure relates generally to Internet-of-Things (IoT) devices, and more particularly to securely connecting IoT devices to wireless access points.

### BACKGROUND

Devices are increasingly becoming internetworked in what is known as the “Internet of Things” (IoT). The IoT allows for data exchange among devices connected to the IoT. Such IoT devices may include, for example, smart devices (e.g., smart phones), buildings, heart monitoring implants, biochip transponders, and other physical devices embedded with electronics, software, sensors, actuators, network connectivity, or a combination thereof. The result of the increased internetworking of the IoT is that more devices are accessible for, e.g., data collection and control, both locally and remotely. For example, an IoT device may be a smart lighting system that a user may control from another IoT device such as a smart phone or tablet computer.

Although useful for coordinating activities among devices, this internetworking leaves devices in the IoT susceptible to vulnerabilities. Specifically, there is a concern regarding unauthorized access to IoT devices by entities other than the intended user. In, for example, a smart home (i.e., a home including various IoT devices), this unauthorized access could be utilized to control locks, to turn devices on or off, to access private information, and the like. In particular, the ability to affect medical devices, such as a medical implant, could be disastrous and may result in death. Thus, there is a need to ensure security for devices connected in the IoT. To this end, there is a need to ensure only authorized communications with devices such as IoT devices, in a network.

It would therefore be advantageous to provide a solution that would secure connections of IoT devices.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for securing communications between Internet of Things (IoT) devices and user devices. The method comprises: establishing a connection to an IoT device over a first secured communication channel, wherein the IoT device is communicatively connected to a wireless network using at least login credentials received from a user device over a second communication channel, wherein the user device is communicatively connected to the wireless network; receiving, from the IoT device, a unique identifier of the user device; and associating the user device with the IoT device, wherein only user devices that are associated with the IoT device can control the IoT device.

Certain embodiments disclosed herein also include a non-transitory computer readable medium having stored thereon instructions for causing a processing circuitry to perform a process, the process comprising: establishing a connection to an Internet of Things (IoT) device over a first secured communication channel, wherein the IoT device is communicatively connected to a wireless network using at least login credentials received from a user device over a second communication channel, wherein the user device is communicatively connected to the wireless network; receiving, from the IoT device, a unique identifier of the user device; and associating the user device with the IoT device, wherein only user devices that are associated with the IoT device can control the IoT device.

Certain embodiments disclosed herein also include a system securing communications between Internet of Things (IoT) devices and user devices, comprising: a processing circuitry; and a memory, the memory containing instructions that, when executed by the processing circuitry, configure the system to: establish a connection to an IoT device over a first secured communication channel, wherein the IoT device is communicatively connected to a wireless network using at least login credentials received from a user device over a second communication channel, wherein the user device is communicatively connected to the wireless network; receive, from the IoT device, a unique identifier of the user device; and associate the user device with the IoT device, wherein only user devices that are associated with the IoT device can control the IoT device.

Certain embodiments disclosed herein also include a method for securing communications between Internet of Things (IoT) devices and user devices, comprising: receiving, from a user device, a unique identifier of an IoT device; generating a password for the IoT device; associating the user device with the IoT device, wherein only user devices that are associated with the IoT device can control the IoT device; and sending the generated password to the user device, when the user device is associated with the IoT device, wherein the password is required by the user device to connect to a secure communication channel utilized by the IoT device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a block diagram of an Internet of Things (IoT) connection manager according to an embodiment.

FIG. 2 is a schematic illustration of an IoT connection manager providing a secure connection between a user device and an IoT device according to an embodiment.

FIG. 3 is a schematic illustration of an IoT connection manager providing a secure connection between a wireless access point and an IoT device according to an embodiment.

FIG. 4 is a flowchart illustrating a method for providing a secure connection between an IoT device and a wireless access point according to an embodiment.

FIG. 5 is a flowchart illustrating a method for associating an IoT device with a user device according to an embodiment.

FIG. 6 is a schematic illustration utilized to describe a method for associating an IoT device with a user device according to another embodiment.

FIG. 7 is a schematic illustration including the IoT connection manager utilized to describe sending control instructions to a controlled IoT device via another IoT device according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include methods and systems for securing communications with Internet of Things (IoT) devices. In an embodiment, a controlling device is configured to send, to a controlled IoT device or an IoT connection manager communicatively connected to the controlled IoT device, control instructions indicating actions to be performed by the controlled IoT device. The IoT connection manager is configured to secure communication of the control instructions to prevent unauthorized access to the controlled IoT device. In an embodiment, the controlling device is a user device configured to identify user inputs and to determine, based on the user inputs, the control instructions. In another, the controlling device is another IoT device configured to receive the control instructions from a user device.

In an embodiment, the controlling device sends the control instructions to the controlled IoT device over a secured communication channel. To this end, in an embodiment, the controlled IoT device broadcasts IoT device identifying information such as, but not limited to, a unique identifier of the controlled IoT device and a network identifier with a randomly generated security token. An IoT connection manager obtains the broadcast identifying information. The controlling device sends, to the IoT connection manager, identifying information for an IoT device. Based on the identifying information broadcast by the IoT device and the identifying information sent by the controlling device IoT connection manager is configured to verify that the controlling device is authorized to control the IoT device and, if so, sends a shared secret of the controlled IoT device to the controlling device. The controlling device sends the shared secret and the control instructions to the IoT device and, when it is determined that the shared secret is verified, the IoT device connects to the IoT connection manager and performs the actions indicated by the control instructions.

In another embodiment, the controlling device sends the control instructions to the IoT connection manager, which forwards the control instructions to the controlled IoT device upon authorization of the controlling device. To this end, in an embodiment, the controlled IoT device broadcasts a public key. A controlling device verifies that the public key belongs to a secure IoT device, and establishes secure communications with the controlled IoT device to send, to the controlled IoT device, configuration data including login credentials and an identifier of the controlling device. An IoT connection manager receives the controlling device identifier or a randomized security token as well as an IoT device identifier and the configuration data from the controlled IoT device. Based on the received identifier or token, the IoT connection manager is configured to verify that the controlling device is permitted to control the controlled IoT device. When the control permission is verified, the IoT connection manager is configured to reconfigure the controlled IoT device based on the received configuration data. The controlled IoT device may reconnect to the IoT connection manager after being reconfigured.

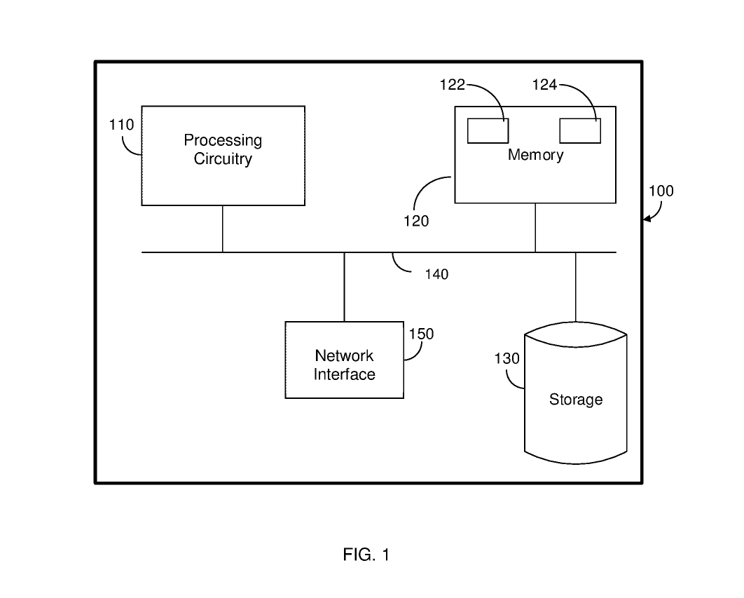

FIG. 1 shows an example block diagram of an Internet of Things (IoT) connection manager 100 according to an embodiment. In an embodiment, the IoT connection manager 100 may be utilized to provide a secure connection between an IoT device and a controlling device via, e.g., a wireless access point (WAP). The IoT connection manager 100 includes a processing circuitry 110, a memory 120, a storage 130, and a network interface 150. In an embodiment, the components of the IoT connection manager are connected via a bus 140.

The processing circuitry 110 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 120 may be volatile (e.g., RAM, etc.), non-volatile (e.g., ROM, flash memory, etc.), or a combination thereof. In one embodiment, computer readable instructions to implement one or more embodiments disclosed herein may be stored in the storage 130. In another embodiment, the memory 120 may be further configured to store a private encryption key of the IoT connection manager 100, public encryption keys, shared secrets, or a combination thereof. Each public encryption key may be associated with an IoT device or a user device, and is known only to the associated IoT device or user device. Each shared secret is known to both the IoT connection manager 100 and to an associated IoT device or user device.

In another embodiment, the memory 120 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 110 to perform the various processes described herein. Specifically, the instructions, when executed, cause the processing system 110 to provide secure connections to IoT devices, as discussed herein.

The storage 130 may be magnetic storage, optical storage, and the like, and may be realized, for example, as flash memory or other memory technology, CD-ROM, Digital Versatile Disks (DVDs), or any other medium which can be used to store the desired information. The storage 130 may store instructions for causing processing circuitries to execute the methods described herein, unique identifiers (e.g., a unique identifier of an IoT device, of a user device, or of a user account associated with an IoT device), and the like.

The network interface 150 allows the IoT connection manager 100 to communicate with, for example, user devices, IoT devices, or both, for purposes such as sending and receiving encryption keys, causing sending of passwords, causing opening of secure communication channels, and the like. The network interface 150 may include a wired connection or a wireless connection.

It should be understood that the embodiments described herein are not limited to the specific architecture illustrated in FIG. 1, and other architectures may be equally used without departing from the scope of the disclosed embodiments.

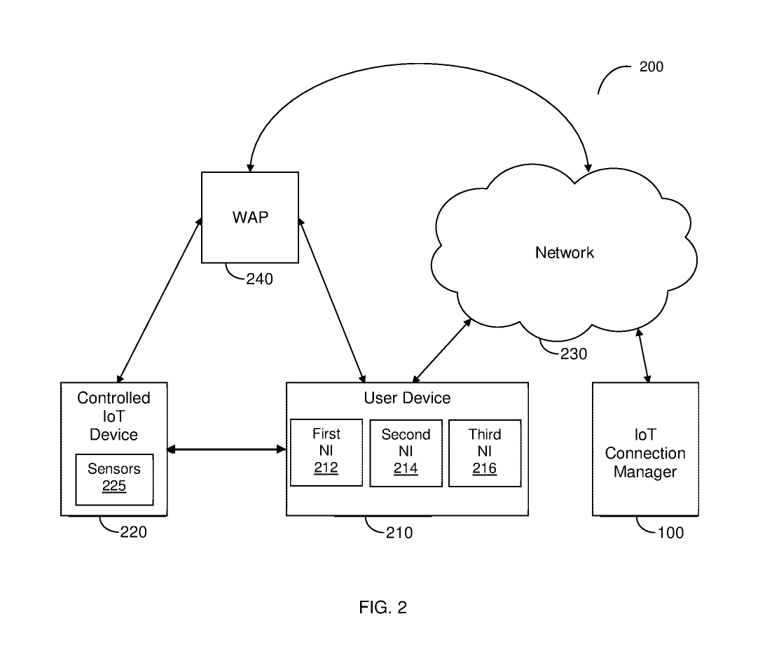

FIG. 2 is an example network diagram 200 including the IoT connection manager 100 utilized to describe the various disclosed embodiments. In the network diagram 200, the IoT connection manager 100 communicates with a WAP 240 over a network 230. The user device 210 establishes communications with a controlled IoT device 220 using the WAP 240 or with the IoT connection manager 100 using the network 230. The network 230 may be, but is not limited to, a cellular or wired network, a local area network (LAN), a wide area network (WAN), a metro area network (MAN), the Internet, the worldwide web (WWW), similar networks, and any combination thereof.

The user device 210 may be, but is not limited to, a personal computer, a laptop, a tablet computer, a smartphone, a wearable computing device, or any other device capable receiving data from and sending data to an IoT device. The user device 210 may be communicatively connected to the IoT device 220 to receive information from the controlled IoT device 220, to send control instructions indicating actions (i.e., control actions such as, e.g., turning the controlled IoT device 220 on or off, adjusting output of the controlled IoT device 220, configuring the controlled IoT device 220 to collect or send particular data, etc.) to be performed by the controlled IoT device 220, to send data to the controlled IoT device 220 (e.g., login credentials which may be utilized to connect to the WAP 240) or a combination thereof.

The controlled IoT device 220 may be, but is not limited to, any device equipped with monitoring capabilities, control capabilities, or both, related to the real world. Examples for the controlled IoT device 220 include smart devices such as, but not limited to, thermostats, lighting systems, electricity monitoring systems, security systems, baby monitoring systems, home appliances, medical devices, smart phones, tablet computers, and the like.

The controlled IoT device 220 may include, but is not limited to, a communication circuit for allowing the IoT connection manager 100, the user device 210, or both, to securely connect (e.g., via a wireless connection) to the controlled IoT device 220. As a non-limiting example, the communication circuit may be configured to open a wireless connection with a WiFi hotspot which is password encrypted. The controlled IoT device 220 is typically configured with a media access control (MAC) address. In some embodiments, the controlled IoT device 220 may be configured to add a security token to a service set identifier (SSID) of the WAP 240. The security token may be a randomly generated single use token. The SSID with the added security token may be utilized as a network identifier for authorizing access to the controlled IoT device 220.

The controlled IoT device 220 may include one or more sensors 225 for detecting environmental parameters such as, but not limited to, light, temperature, movement, audio, location, wind, pressure, combinations thereof, and the like. The sensors 225 may include, but are not limited to, accelerometers, gyroscopes, cameras, global navigation satellite systems (e.g., GPS), temperature sensors, light sensors, motion detectors, combinations thereof, and the like.

In an embodiment, the user device 210 may be communicatively connected to the controlled IoT device 220 for the purpose of controlling the IoT device 220 such that the IoT device 220 may be powered on or off based on signals from the user device 210. More specifically, as a further example, the user device 210 may be a tablet computer and the IoT device 220 may be a smart lighting system installed in a home, where the tablet computer may be utilized to cause lights in the home to turn on, to turn off, or to change light intensity.

In an embodiment, the user device 210 includes a first network interface 212 for communicating with the WAP 240. The first network interface 212 may be, but is not limited to, a Wi-Fi interface. In a further embodiment, the user device includes a second network interface for communicating with the controlled IoT device 220. The second network interface 214 may provide local or personal area wireless networking, and may be, but is not limited to, a Bluetooth interface, a Near Field Communication (NFC) interface, a ZigBee interface, a Wi-Fi interface, or a combination thereof. In another embodiment, the user device 210 includes a third network interface 216 for communicating with the network 230. The third network interface 216 may provide, for example, cellular connectivity to the network 230 such as, but not limited to, through a mobile network operator with which the user device 210 is associated. Associations of the user device 210 may be based on, but not limited to, a subscriber identity module (SIM) of the user device 210.

The WAP 240 provides wireless access to the network 230. In an example embodiment, the WAP 240 may be a modem-router. A modem-router typically provides both modem functionality and router functionality. To this end, in an embodiment, the WAP 240 may connect to an Internet service provider (ISP) and provide access to one or more devices communicatively connected to the ISP via the WAP 240.

It should be noted that the embodiments described herein above with respect to FIG. 2 are discussed with reference to a single user device 210 and a single IoT device 220 merely for simplicity purposes and without limitation on the disclosed embodiments. Communications between multiple user devices with an IoT device, between a user device with multiple IoT devices, or both, may be equally utilized without departing from the scope of the disclosed embodiments.

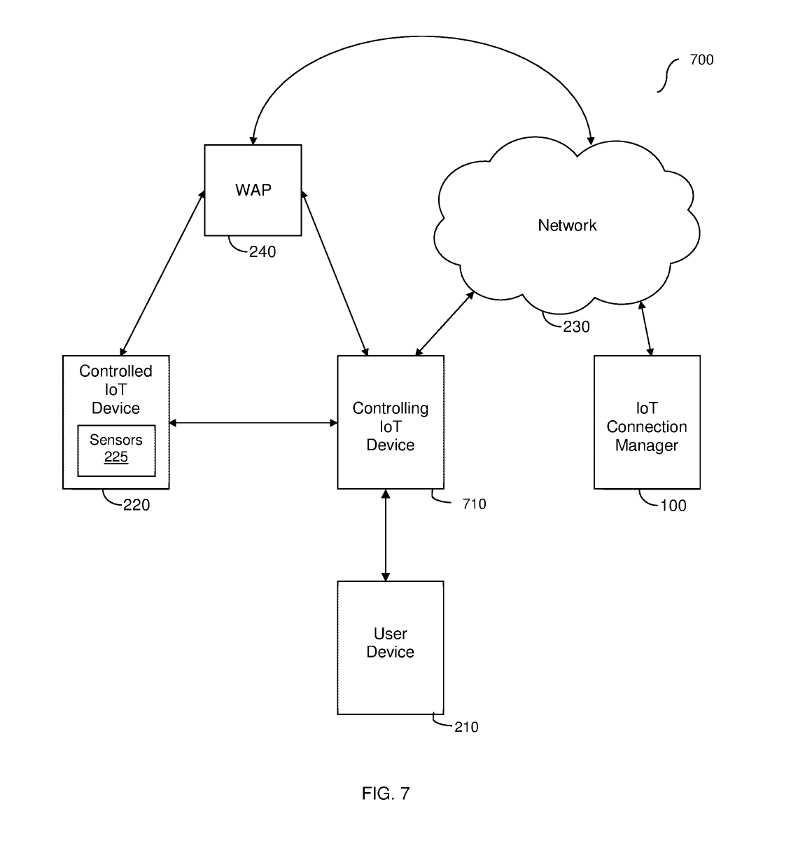

It should be further noted that the user device 210 may be communicatively connected to another IoT device (e.g., as shown in FIG. 7, described herein below) and may send, to the other IoT device, control instructions indicating actions to be performed by the controlled IoT device. The other IoT device may be authorized by the IoT connection manager 100, the user device 210, or both, and may communicate the control instructions once authorized.

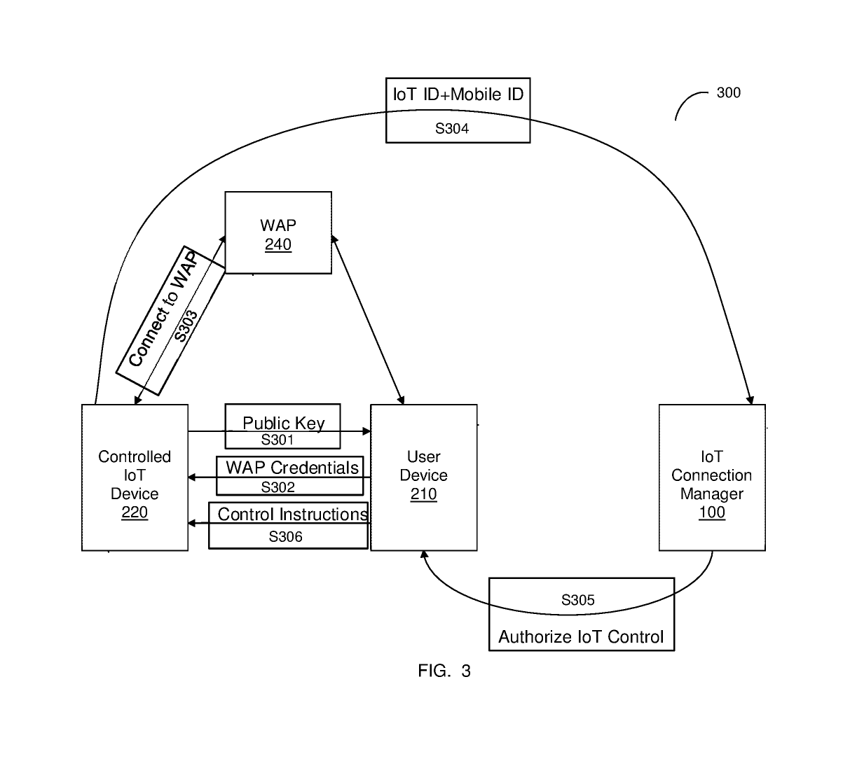

In an embodiment, the IoT connection manager 100 is configured to assist in securely establishing communications between the IoT device 220 to the WAP 240. FIG. 3 is an example communications diagram 300 illustrating securing communications between the IoT device 220 and the user device 210 authorized by the IoT connection manager 100 according to an embodiment.

In the example communications diagram 300, the IoT device 220 transmits (S301) a public encryption key to the user device 210 over a first communication channel. In an embodiment, the first communication channel may be unsecured. As an example, the transmission over the first communication channel may be a broadcast, i.e., not directed to a particular device. In another embodiment, the transmission may designate identifying information of the IoT device 220 such that the first communication channel is secured. The identifying information may include, but is not limited to, an identifier of the IoT device 220, a network identifier of the WAP 240, or both. The identifier of the controlled IoT device 220 may include, but is not limited to, a MAC address of the controlled IoT device 220. The network identifier may include, but is not limited to, a SSID of the WAP 240, and may further include a security token. The security token may be a randomly generated single use token added to the SSID which can be utilized to authenticate a controlling device.

In another embodiment, a public encryption key may be utilized for accessing the WAP 240. In a further embodiment, the user device 210 may encrypt and send (S302) login credentials for accessing the WAP 240 to the IoT device 220. The login credentials may include, but are not limited to, a password. The password may meet one or more standards for encryption such as, but not limited to, Wired Equivalent Privacy (WEP), Wi-Fi Protected Access (WPA), and the like. In yet a further embodiment, the IoT device 220 receives the login credentials and subsequently utilizes the login credentials for accessing the WAP 240.

In a further embodiment, the sending (S302) may further include sending, to the IoT device 220, a unique identifier of the user device 210. The unique identifier may be, but is not limited to, a media access control (MAC) address of the user device, an international mobile subscriber identity (IMSI), and the like. The unique identifier of the user device 210 may be utilized for, e.g., associating the user device 210 with the IoT device 220 as an authorized device.

In an embodiment, the IoT device 220 connects (S303) to the WAP 240 in order to gain network access (e.g., to the network 230, FIG. 2). The network access may further allow communications between the IoT device 220 and the IoT connection manager 100. In a further embodiment, upon establishment of a connection between the IoT device 220 and the WAP 240, the IoT device 220 may be configured to send (not shown), to the IoT connection manager 100, a notification indicating that the IoT device 220 is connected to the WAP 240.

In an embodiment, the IoT device 220 establishes a connection to the IoT connection manager 100 via a secure communication channel and sends (S304) at least the unique identifier of the user device 210 to the IoT connection manager 100. In a further embodiment, the IoT device 220 may further send its a unique identifier to the IoT connection manager.

In an embodiment, when the IoT connection manager 100 receives the unique identifier of the user device 210, the unique identifier of the IoT device 220, or both, the IoT connection manager is configured to associate the IoT device 220 with the user device 210, thereby authorizing the user device 210 to control the IoT device 210. In another embodiment, the IoT connection manager 100 is configured to generate a user account for the user device 210, and to associate the IoT device 220 with the user device 210, the generated user account, or both. In yet another embodiment, the IoT connection manager 100 is configured to send (S305) a success notification regarding the authorization, for example to the user device 210, to the IoT device 220, or both. The success notification may further include information related to the generated user account. In a further embodiment, if the first communication channel is unsecured, when the success notification is received by the IoT device 220, the IoT device 220 is configured to close the first unsecured communication channel and to initiate a secured connection via the WAP 240.

As noted above, in an embodiment, the IoT connection manager 100 may include a storage 130. The storage 130 may store a database of identifiers of a plurality of accounts of IoT devices, including the IoT device 220. In a further embodiment, the IoT connection manager 100 may be configured to assign each IoT device account to a single user device, such as the user device 210, of a user device account. This assignment may be based on the unique identifier of the user device 210 discussed herein above.

In an embodiment, once an IoT device 220 is assigned to a user device 210, only that user device is authorized to send control instructions to the IoT device, thereby preventing other, unauthorized devices from controlling the IoT device. In another embodiment, the user device 210 may send, to the IoT connection manager 100, an instruction to un-assign the IoT device 220 from the user device 210. In yet another embodiment, the user device 210 may send, to the IoT connection manager 100, an instruction to grant access to the IoT device 220 to additional user devices. The instruction to grant access to additional devices may include, e.g., a unique identifier of each additional device.

In another embodiment, the IoT connection manager 100 is configured to send, to the user device 210 and to the IoT device 220, a shared secret. The shared secret may be utilized to, for example, allow granting of access between the user device 210 and the IoT device 220 when the user device 210, the IoT device 220, or both, are not communicatively connected to the IoT connection manager 100. In a further embodiment, the IoT connection manager 100 may be configured to revoke access granted via the shared secret by, e.g., sending a notification indicating the revocation of access. Subsequent access may be granted by generating and sending a new shared secret.

In yet another embodiment, the IoT connection manager 100 may be configured to grant access between the IoT device 220 and the user device 210 by sending, to the IoT device 220, a public encryption key associated with the user device 210. In a further embodiment, the IoT connection manager 100 may be configured to revoke access granted by sending the public encryption key by, e.g., sending a notification indicating the revocation of access.

It should be noted that various embodiments discussed herein above are described with respect to associating user devices with IoT devices merely for simplicity purposes and without limitation on the disclosed embodiments. An IoT device may be associated with a user account of a user device in addition to or instead of being associated with the user device itself without departing from the scope of the disclosure. Additionally, a user device, a user account of the user device, or both may be associated with an account of an IoT device without departing from the scope of the disclosure.

In an embodiment, the IoT connection manager 100 is configured to send (S306), to the IoT device 220, an instruction to configure the IoT device 220 to receive instructions and commands from the user device 210. In a further, configuring the IoT device 220 may include sending, to the user device 210 and to the IoT device 220, a shared secret, and configuring the IoT device 220 to accept commands from the user device 210 only when the user device 210 sends the shared secret.

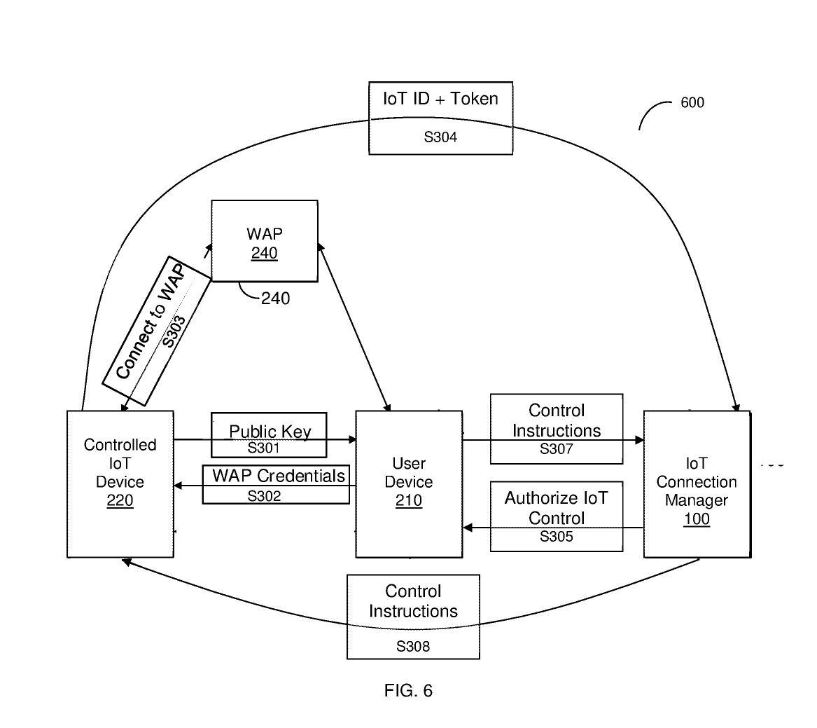

In another embodiment, control of the IoT device 210 may be performed via the IoT connection manager 100. An example communications diagram 600 illustrating controlling the IoT device 210 via the IoT connection manager 100 is shown in FIG. 6. In an embodiment, the user device 210 is configured to send (S307), to the IoT connection manager 100, a control instruction for the IoT device 220. In yet a further embodiment, when the control instruction for the IoT device 220 is received from the user device 210, the IoT connection manager 100 may determine whether the user device 210 is an authorized device of the IoT device 220. If it is determined that the user device 210 is an authorized device of the IoT device 220, the IoT connection manager 100 is configured to cause configuration of the IoT device 220 to perform the control instruction.

Returning to FIG. 3, in another embodiment, the IoT connection manager 100 may be configured to determine whether the IoT device 220 is already associated with another user device (not shown) when an identifier of the user device 210 to be authorized is received. In a further embodiment, if it is determined that the IoT device 220 is already associated with another user device, the IoT connection manager 100 may deny the authorization of the user device 210 to access the IoT device 220.

It should be noted that FIGS. 3 and 6 are depicted using direct connections among the user device 210, the IoT device 220, the WAP 240, and the IoT connection manager 100 merely for simplicity purposes and without limitation on the disclosed embodiments. Communications among any of the user device 210, the IoT device 220, the WAP 240, and the IoT connection manager 100 may be via a network (e.g., the network 230) without departing from the scope of the disclosure. In particular, it should be further noted that sending S304 the IoT ID and the user device ID to the IoT connection manager 100 as well as sending S305 a notification regarding authorization of the user device 210 to the user device 210 may be performed via the WAP 240 without departing from the scope of the disclosure.

It should be further noted that FIGS. 3 and 6 are depicted as including connections between the user device 210 and the controlled IoT device 220, the WAP 240, and the IoT connection manager 100 merely for example purposes. In other embodiments, the user device 210 may equally send control instructions to another IoT device (e.g., as depicted in FIG. 7, described further herein below), which may establish communications with the controlled IoT device 220, the WAP 240, the IoT connection manager 100, or a combination thereof. Accordingly, the other IoT device may be utilized to securely communicate the control instructions instead of the user device 210.

It should also be noted that the IoT connection manager 100 may be deployed in a datacenter, a cloud computing platform (e.g., a public cloud, a private cloud, or a hybrid cloud), on-premises of an organization (e.g., at a geographical location in which the IoT device 220, the user device 210, the WAP 240, or a combination thereof are deployed), or in a combination thereof. It should be noted that the IoT connection manager 100 can be deployed in a different geographical location from other components of the communications diagram 300.

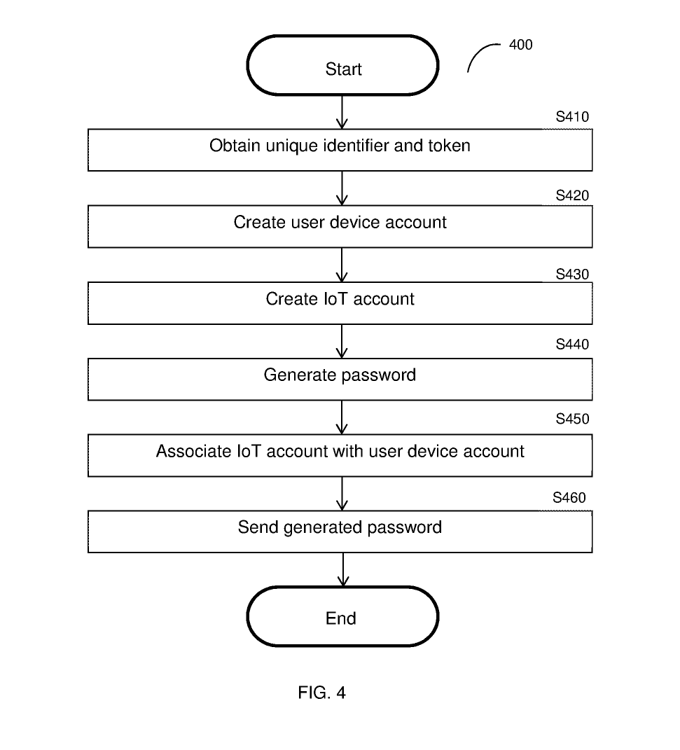

FIG. 4 is an example flowchart 400 illustrating a method for associating an IoT device with a user device according to an embodiment. In an embodiment, the method may be performed by an IoT connection manager (e.g., the IoT connection manager 100) to authorize a user device (e.g., the user device 210) for controlling an IoT device (e.g., the IoT device 220).

At S410, at least one unique identifier and a security token are received. The at least one unique identifier and token may be received from a user device (e.g., the user device 210) that, in turn, received the unique identifier and token from an IoT device (e.g., the controlled IoT device 220). The at least one unique identifier may include, but is not limited to, a media access control (MAC) address. The security token may be included in a hotspot opened by the IoT device, as described further herein above with respect to FIG. 2. In an embodiment, the security token is a single use token that can only be used once.

At S420, a user device account is created for the user device. The user device account may include, but is not limited to, a username, a password, a unique identifier of the user device, and the like. In another embodiment, S420 may include checking if a user device account already exists for the user device and, if so, using the existing user device account. In some embodiments, S420 may include checking if a user device account of the user device is stored in a database accessible to the IoT connection manager and, if so, using the stored user device account.

At S430, an IoT device account is created for the IoT device to be controlled. The IoT device account may include information related to the IoT device such as, but not limited to, a MAC address of the IoT device, an IoT device type, a unique identifier of the IoT device, and the like. In some embodiments, S430 may include checking if an IoT device account of the IoT device is stored in a database accessible to the IoT connection manager and, if so, using the stored IoT device account.

In an embodiment, the IoT device account is generated when the unique identifier of the IoT device and a randomized security token are received from the user device. The IoT device unique identifier and randomized security token may be, e.g., included in a request to grant access to control over the IoT device. To this end, in an embodiment, S430 may include receiving, from the user device, a request including the unique identifier and token.

At S440, a password is generated for the IoT device. The password is required by the user device to connect to a secure communication channel utilized by the controlled IoT device.

At S450, the IoT device account is associated with the user device account, thereby authorizing the user device to control the IoT device. In some embodiments, “N” IoT device accounts may be associated with “M” user accounts, where “N” and “M” are integers having a value of 1 or more. In another embodiment, if an IoT device account is associated with more than one user device account, one of the user device accounts may be designated as a primary user device account. The primary user device account may be allowed to, e.g., un-assign other user devices or user device accounts from controlling the IoT device, grant access to additional user devices or user device accounts from controlling the IoT device, or both.

At S460, the generated password is sent to the user device that has been authorized to control the IoT device. In an embodiment, the generated password is sent over a secure communication channel.

Once authorized for controlling the IoT device, the user device may utilize the generated password to connect to the IoT device over a secure communication channel. When the user device is connected to the IoT device over the secure communication channel, the user device may provide login credentials for enabling the IoT device to connect to a wireless access point (WAP, such as the WAP 240). The login credentials may include, but are not limited to, a password, which may, in an embodiment, meet one or more standards noted above. The IoT device may connect to an IoT connection manager (e.g., the IoT connection manager 100) via the WAP. In another embodiment, the user device may send, to the IoT device, a plurality of WAP identifiers (e.g., a plurality off SSIDs) as well as login credentials for connecting to each WAP.

In an embodiment, upon receiving a connection request from the IoT device, the IoT connection manager may be configured to authenticate the association between a user device account of the user device and an IoT account of the IoT. In a further embodiment, the authentication may include receiving, from the IoT device, a user device identifier of the user device and checking, based on the received user device identifier, if the user device account of the user device is associated with the IoT account of the IoT device. In another embodiment, the IoT connection manager may be configured to send, to the user device, a notification indicating the successful establishment of control over the IoT device.

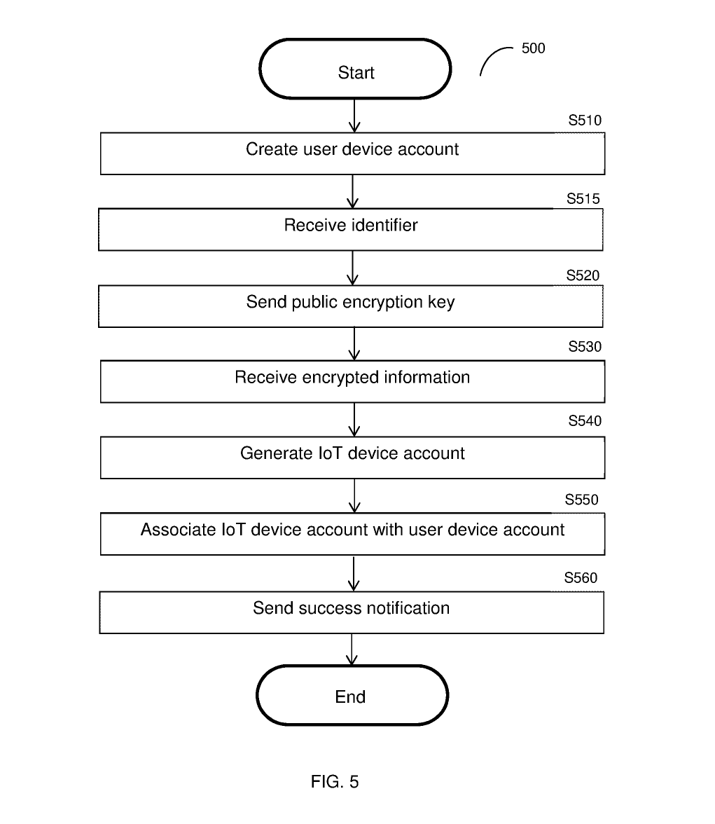

FIG. 5 is an example flowchart 500 illustrating a method for associating an IoT device with a user device according to another embodiment. In an embodiment, the method may be performed by an IoT connection manager (e.g., the IoT connection manager 100) to authorize a user device (e.g., the user device 210) for accessing an IoT device (e.g., the IoT device 220).

At S510, a user device account is generated for the user device. The user device account may include, but is not limited to, a username, a password, a unique identifier of the user device, and the like. In another embodiment, S510 may include checking if a user device account of the user device is stored in a database accessible to the IoT connection manager and, if so, using the existing user device account.

At S515, a unique identifier of an IoT device to be controlled is received. In an embodiment, the unique identifier may be received from a user device. In a further embodiment, the unique identifier may be included in a request for a security token to allow control over the IoT device.

At optional S520, when a unique identifier of an IoT device to be controlled is received, a public encryption key may be sent to the user device. The public encryption key may be utilized by the user device to encrypt information from the user device such as, but not limited to, the WAP login credentials, the unique identifier of the user device, and the like. The user device may send the encrypted information to the IoT device, which decrypts the encrypted information. The user device may send the encrypted information to the IoT device via a network interface that provides local or personal area wireless networking, which may be, for example, a Bluetooth interface, a Near Field Communication (NFC) interface, a ZigBee interface, a Wi-Fi interface, or a combination thereof. In response to decrypting the information from the user device, the IoT device may re-encrypt the information received from the user device. In another embodiment, the IoT device may send the encrypted information received from the user device to the IoT connection manager without first decrypting and re-encrypting the information.

In an embodiment, S520 may further include receiving the re-encrypted information from the IoT device. It should be noted that, in another embodiment, a public encryption key may be send to the user device prior to receiving encrypted information from the IoT device, and the IoT device may encrypt information including the unique identifier of the IoT device using the public encryption key.

In some implementations, the user device may be configured to verify the sent public encryption key, thereby verifying that the IoT device is a valid recipient of control instructions. Alternatively or collectively, the user device may be configured to verify the IoT device based on the unique identifier.

At S530, encrypted information is received from the IoT device. The encrypted information may include, but is not limited to, WAP login credentials (e.g., a WiFi password), a unique identifier of the user device (e.g., a MAC address of the user device), a unique identifier of an IoT device, a combination thereof, and the like. In an embodiment, the encrypted information may be received via a secure communication channel using a WAP. The WAP login credentials may be login credentials that were received by the IoT device from the user device.

In some implementations, the encrypted information is received from the IoT device when the IoT device connects to a WAP and initiates an encrypted connection with the IoT connection manager. In a further implementation, the IoT connection manager may verify the connecting IoT device based on a security token and a unique identifier of the IoT device.

At S540, an IoT device account is generated for the IoT device. The IoT device account may include information related to the IoT device such as, but not limited to, a MAC address of the IoT device, an IoT device type, a unique identifier, and the like. In some embodiments, S540 may include checking if an IoT device account of the IoT device is stored in a database accessible to the IoT connection manager and, if so, using the stored IoT device account

At S550, the IoT device account is associated with the user device account, thereby authorizing the user device to control the IoT device. In some embodiments, “N” IoT device accounts may be associated with “M” user accounts, where “N” and “M” are integers having a value of 1 or more. In another embodiment, if an IoT device account is associated with more than one user device account, one of the user device accounts may be designated as a primary user device account. The primary user device account may be allowed to, e.g., un-assign other user devices or user device accounts from controlling the IoT device, grant access to additional user devices or user device accounts from controlling the IoT device, or both.

At S560, when the IoT device account has been associated with the user device account, a success notification may be sent. The success notification may be sent to, e.g., the user device, the IoT device, or both. The success notification may trigger authorization of the user device to send control instructions to the IoT device via the IoT connection manager by causing configuration of the IoT device to receive instructions from the user device.

FIG. 7 is an example network diagram 700 including the IoT connection manager 100 utilized to describe sending control instructions to a controlled IoT device via another IoT device according to some embodiments. It should be noted that the example network diagram 700 is described with respect to components of the network diagram 200 merely for simplicity purposes. In the network diagram 700, the IoT connection manager 100 communicates with the WAP 240 over the network 230. An IoT device 710 is communicatively connected to the user device 210 and may be configured to receive control instructions from the user device 210 indicating actions to be performed by the controlled IoT device 220. The IoT device 710 establishes communications with the controlled IoT device 220 using the WAP 240 or with the IoT connection manager 100 using the network 230. In the example network diagram 700, the IoT device 710 may perform communications pursuant to receiving authorization, receiving keys or identifying information, sending control instructions, or a combination thereof, for example as performed by the user device as described herein above. Thus, the IoT device 710 may be utilized to secure communication of control instructions from the user device 210.

It should be noted that, in some embodiments, an indication that the IoT device has been successfully associated with the user device may be sent to the user device when the IoT device account has been associated with the user device account. To this end, the user device may include a second network interface for establishing a second communication channel. In another embodiment, the user device account may be associated with the IoT device account when a unique identifier of an IoT device is received from the user device. In a further embodiment, the IoT identifier may be encrypted using the public key received from the IoT device. This encryption ensues intentional communications as opposed to unintentional communications between an unauthorized user device and the IoT device. It should be noted that various embodiments disclosed herein are discussed with respect to particular cryptographic methods merely for simplicity purposes and without limitation on the disclosed embodiments. Other cryptographic methods, both now known and hereinafter discovered, may be equally utilized without departing from the scope of the disclosure.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for securing communications between Internet of Things (IoT) devices and user devices, comprising:
establishing a connection to an IoT device over a first secured communication channel, wherein the IoT device is communicatively connected to a wireless network using at least login credentials received from a user device over a second communication channel, wherein the user device is communicatively connected to the wireless network;
receiving, from the IoT device, a unique identifier of the user device; and
associating the user device with the IoT device, wherein only user devices that are associated with the IoT device can control the IoT device.

2. The method of claim 1, wherein the received unique identifier is encrypted by the user device using a public encryption key of the IoT device received from the IoT device, further comprising:
decrypting, using a private encryption key corresponding to the public encryption key of the IoT device, the received encrypted identifier.

3. The method of claim 1, further comprising:
sending, to the IoT device, an instruction to accept control instructions only from the associated user device.

4. The method of claim 3, wherein the method is executed by an IoT connection manager, further comprising:
sending, to the IoT device, an instruction to accept control instructions from the IoT connection manager.

5. The method of claim 3, further comprising:
receiving, from the associated user device, an instruction to associated a second user device with the IoT device; and
sending, to the IoT device, an instruction to accept control instructions from the second user device.

6. The method of claim 1, further comprising:
generating a user device account for the user device; and
generating an IoT device account for the IoT device.

7. The method of claim 6, wherein associating the user device with the IoT device further comprises:
associating the user device account with the IoT device account.

8. A non-transitory computer readable medium having stored thereon instructions for causing a processing circuitry to perform a process, the process comprising:
establishing a connection to an Internet of Things (IoT) device over a first secured communication channel, wherein the IoT device is communicatively connected to a wireless network using at least login credentials received from a user device over a second communication channel, wherein the user device is communicatively connected to the wireless network;
receiving, from the IoT device, a unique identifier of the user device; and
associating the user device with the IoT device, wherein only user devices that are associated with the IoT device can control the IoT device.

9. A system securing communications between Internet of Things (IoT) devices and user devices, comprising:
a processing circuitry; and
a memory, the memory containing instructions that, when executed by the processing circuitry, configure the system to:
establish a connection to an IoT device over a first secured communication channel, wherein the IoT device is communicatively connected to a wireless network using at least login credentials received from a user device over a second communication channel, wherein the user device is communicatively connected to the wireless network;
receive, from the IoT device, a unique identifier of the user device; and
associate the user device with the IoT device, wherein only user devices that are associated with the IoT device can control the IoT device.

10. The system of claim 9, wherein the received unique identifier is encrypted by the user device using a public encryption key of the IoT device received from the IoT device, wherein the system is further configured to:
decrypt, using a private encryption key corresponding to the public encryption key of the IoT device, the received encrypted identifier.

11. The system of claim 9, wherein the system is further configured to:
send, to the IoT device, an instruction to accept control instructions only from the associated user device.

12. The system of claim 11, wherein the method is executed by an IoT connection manager, wherein the system is further configured to:
send, to the IoT device, an instruction to accept control instructions from the IoT connection manager.

13. The system of claim 11, wherein the system is further configured to:
receive, from the associated user device, an instruction to associated a second user device with the IoT device; and
send, to the IoT device, an instruction to accept control instructions from the second user device.

14. The system of claim 9, wherein the system is further configured to:
generate a user device account for the user device; and
generate an IoT device account for the IoT device.

15. The system of claim 14, the system is further configured to:
associate the user device account with the IoT device account.

16. A method for securing communications between Internet of Things (IoT) devices and user devices, comprising:
receiving, from a user device, a unique identifier of an IoT device;
generating a password for the IoT device;
associating the user device with the IoT device, wherein only user devices that are associated with the IoT device can control the IoT device; and
sending the generated password to the user device, when the user device is associated with the IoT device, wherein the password is required by the user device to connect to a secure communication channel utilized by the IoT device.

17. The method of claim 16, further comprising:
generating a user device account for the user device; and
generating an IoT device account for the IoT device.

18. The method of claim 6, wherein associating the user device with the IoT device further comprises:
associating the user device account with the IoT device account.
